(19) United States
(12) Patent Application Publication
(10) Pub. No.: US 2025/0368148 A1
(43) Pub. Date: Dec. 4, 2025

(54) BRACKET FOR VEHICLE-MOUNTED APPARATUS

(71) Applicant: NIFCO INC., Yokosuka-shi, Kanagawa (JP)

(72) Inventor: Daisuke SATO, Yokosuka-shi, Kanagawa (JP)

(21) Appl. No.: 18/876,662

(22) PCT Filed: Jul. 12, 2023
(86) PCT No.: PCT/JP2023/025745

§ 371 Date: Dec. 19, 2024

(30) Foreign Application Priority Data
Aug. 1, 2022 (JP) 2022-122565

(51) Int. Cl. B60R 11/04; B60R 11/00

(52) U.S. Cl. CPC B60R 11/04; B60R 2011/0026

(57) ABSTRACT

To simplify and downsize a bracket for a vehicle-mounted apparatus in an appropriate and reasonable manner, a receiving part of the vehicle-mounted apparatus includes a positioning wall portion for a front portion or a rear portion of the vehicle-mounted apparatus and an elastically deformable portion having a strip shape extending along a front-rear direction from a base located to face the positioning wall portion. The elastically deformable portion is provided with an engaging portion for an engaged portion formed on a side portion of the vehicle-mounted apparatus. The bracket allows moving operation of the vehicle-mounted apparatus to a holding completion position in the receiving part by deformation of the elastically deformable portion due to contact of the engaged portion with the engaging portion, and elastic return of the elastically deformable portion brings the vehicle-mounted apparatus in the holding completion position into contact with the positioning wall portion and prevents the vehicle-mounted apparatus from slipping out of the receiving part.

### TECHNICAL FIELD

The present invention relates to an improvement in a bracket used to hold a vehicle-mounted apparatus, such as for taking a picture outside a vehicle through a window glass, to a body of a vehicle.

### BACKGROUND

A bracket for mounting a camera for taking a picture outside a vehicle through the windshield of the vehicle on the inside of the windshield is described in Patent Literature 1.

The bracket in Patent Literature 1 has an engaging protrusion formed on the rear side face of the camera. The bracket is provided with a locking portion against which the engaging protrusion butts from behind, and a plate spring, which is located behind the locking portion, that accepts the engaging protrusion in an elastically deformed state between the locking portion and the plate spring.

### CITATION LIST

### Patent Literature

Patent Literature 1: Japanese Unexamined Patent Application Publication No. 2017-171168

### SUMMARY

### Technical Problem

This type of bracket is typically mounted on an upper portion of window glass, often occupying a certain area. In addition, a rear-view mirror and other equipment are needed to be disposed around the bracket. Therefore, from the viewpoint of providing freedom in the layout of the cabin, this type of bracket is required to be as compact as possible.

A main object to be achieved by this invention is to make it possible to simplify and downsize this type of bracket for a vehicle-mounted apparatus in an appropriate and reasonable manner.

### Solution to Problem

In order to achieve the object, the present invention, from a first viewpoint, describes a bracket for a vehicle-mounted apparatus,
the bracket being configured to hold, on a body of a vehicle, a vehicle-mounted apparatus for taking a picture or sensing an outside of the vehicle through a window glass, the bracket comprising:
a fixing portion to the body of the vehicle, and a portion opposite to the fixing portion as a receiving part for at least a part of the vehicle-mounted apparatus, wherein
the receiving part includes
   a positioning wall portion for a front portion or a rear portion of the vehicle-mounted apparatus, and
   an elastically deformable portion having a strip shape extending along a front-rear direction from a base located to face the positioning wall portion,
the elastically deformable portion is provided with an engaging portion in a protruding shape for an engaged portion formed on a side portion of the vehicle-mounted apparatus, and
the bracket allows moving operation of the vehicle-mounted apparatus to a holding completion position in the receiving part by deformation of the elastically deformable portion due to contact of the engaged portion with the engaging portion, and elastic return of the elastically deformable portion brings the vehicle-mounted apparatus in the holding completion position into contact with the positioning wall portion and prevents the vehicle-mounted apparatus from slipping out of the receiving part.

In order to achieve the object, the present invention, from a second viewpoint, describes a bracket for a vehicle-mounted apparatus,
the bracket being configured to hold, on a body of a vehicle, a vehicle-mounted apparatus for taking a picture or sensing an outside of the vehicle through a window glass, the bracket including:
a fixing portion to the body of the vehicle, and a portion opposite to the fixing portion as a receiving part for at least a part of the vehicle-mounted apparatus, wherein
the receiving part includes
   a positioning wall portion for a front portion or a rear portion of the vehicle-mounted apparatus,
   an engaging portion for an engaged portion formed on a side portion of the vehicle-mounted apparatus, and
   a supporting portion that enables support of a supported portion formed on the vehicle-mounted apparatus at a different position from the engaging portion,
the engaging portion is formed in an elastically deformable portion in the receiving part, and
the bracket allows a moving operation of the vehicle-mounted apparatus from a first position of the vehicle-mounted apparatus, where the supported portion is supported by the supporting portion and a portion of the bracket forming the engaged portion of the vehicle-mounted apparatus is not fully contained in the receiving part, to a second position, where the portion of the bracket forming the engaged portion of the vehicle-mounted apparatus is fully contained in the receiving part, with the supported portion used as a fulcrum, by deformation of the elastically deformable portion due to contact of the engaged portion with the engaging portion, and an elastic return of the elastically deformable portion brings the vehicle-mounted apparatus in the second position into contact with the positioning wall portion and prevents the vehicle-mounted apparatus from returning to the first position.

In the invention according to the second viewpoint, an aspect of the invention is that the elastically deformable portion has a strip shape extending along a front-rear direction from a base located near the positioning wall portion,
the engaging portion is provided in a protruding shape from the elastically deformable portion, and
a slope formed to face the positioning wall portion and included in the engaging portion contacts the engaged portion in the second position.

It is also an aspect of the invention that a support face facing upward and included in the engaging portion is positioned to enter below the vehicle-mounted apparatus in the second position.

It is also an aspect of the invention that a guide face is formed below the support face in the engaging portion, the guide face decreasing the amount of protrusion of the engaging portion as the guide face extends downward.

It is also an aspect of the invention that the bracket includes an additional elastically deformable portion that is pressed against an upper portion of the vehicle-mounted apparatus in the second position.

In addition, in the invention according to the first or the second aspect, it is an aspect of the invention that the elastically deformable portion is provided on each side of a hypothetical center line along a front-rear direction that bisects the receiving part into left and right halves, the elastically deformable portion being provided with the engaging portion protruding toward the center line, the engaging portion corresponding to the engaged portion formed on each of left and right side portions of the vehicle-mounted apparatus.

### Advantageous Effects of Invention

According to the present invention, the moving operation to hold the vehicle-mounted camera in the receiving part of the bracket is allowed by the deformation of the elastically deformable portion due to the contact of the engaged portion with the engaging portion. The elastic return of the elastically deformable portion brings the vehicle-mounted apparatus into contact with the positioning wall portion and prevents the vehicle-mounted apparatus from slipping out of the receiving part. Therefore, the vehicle-mounted apparatus can be held without requiring a separate structure, which forces the vehicle-mounted apparatus against the positioning wall portion, in front of or behind the vehicle-mounted camera. In addition, the bracket can be made as simple and compact as possible because it does not require a separate structure on the left or right side of the vehicle-mounted apparatus other than the elastically deformable portion and the engaging portion, nor does it require a separate structure that protrudes below the vehicle-mounted apparatus.

### BRIEF DESCRIPTION OF DRAWINGS

FIG. 1 is a perspective configuration diagram of a vehicle-mounted camera held by a bracket according to an embodiment of the present invention.

FIG. 2 is a perspective configuration diagram of the vehicle-mounted camera viewed from a different orientation than that in FIG. 1.

FIG. 3 is a perspective configuration diagram of a bracket according to an embodiment of the present invention as viewed from above.

FIG. 4 is a perspective configuration diagram of the bracket as viewed from below.

FIG. 5 is a perspective configuration diagram of a main part of the bracket.

FIG. 6 is a perspective configuration diagram of a main part of the bracket.

FIG. 7 is a perspective configuration diagram of a main part illustrating a state in which the vehicle-mounted camera is held by the bracket.

FIG. 8 is a perspective configuration diagram of a main part illustrating the state in which the vehicle-mounted camera is held by the bracket.

FIG. 9 is a sectional configuration diagram illustrating the bracket attached to a front window in cross section at a center line L2 position in FIG. 10.

FIG. 10 is a bottom configuration diagram of a main part of the bracket.

FIG. 11 is a side configuration diagram of a main part illustrating a state in which a part of the vehicle-mounted camera is received in a receiving part of the bracket, with the vehicle-mounted camera placed in an oblique position, and a supported portion is in front of a supporting portion, which is not yet supported.

FIG. 12 is a bottom configuration diagram of the main part in the state of FIG. 11.

FIG. 13 is a side configuration diagram of a main part illustrating a state in which a part of the vehicle-mounted camera is received in the receiving part of the bracket, with the vehicle-mounted camera placed in an oblique position, and the supported portion is supported by the supporting portion.

FIG. 14 is a bottom configuration diagram of the main part in the state of FIG. 13.

FIG. 15 is an enlarged configuration diagram of the main part in FIG. 14.

FIG. 16 is a side configuration diagram of a main part illustrating a state in which moving operation of the vehicle-mounted camera has been performed to a position where the vehicle-mounted camera is horizontal in the receiving part of the bracket.

FIG. 17 is a bottom configuration diagram of the main part in the state of FIG. 16.

FIG. 18 is an enlarged configuration diagram of the main part in FIG. 17.

FIG. 19 is a side configuration diagram illustrating a state in which the vehicle-mounted camera is moved slightly forward from the state in FIG. 17 to a holding completion position.

FIG. 20 is a bottom configuration diagram of the main part in the state of FIG. 19.

FIG. 21 is an enlarged configuration diagram of the main part in FIG. 20.

### DESCRIPTION OF EMBODIMENTS

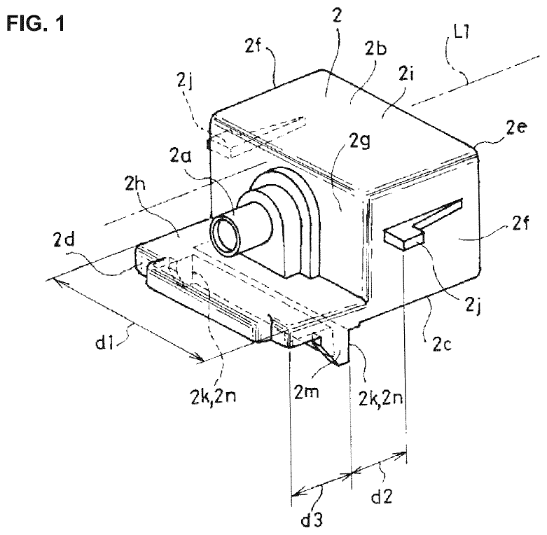

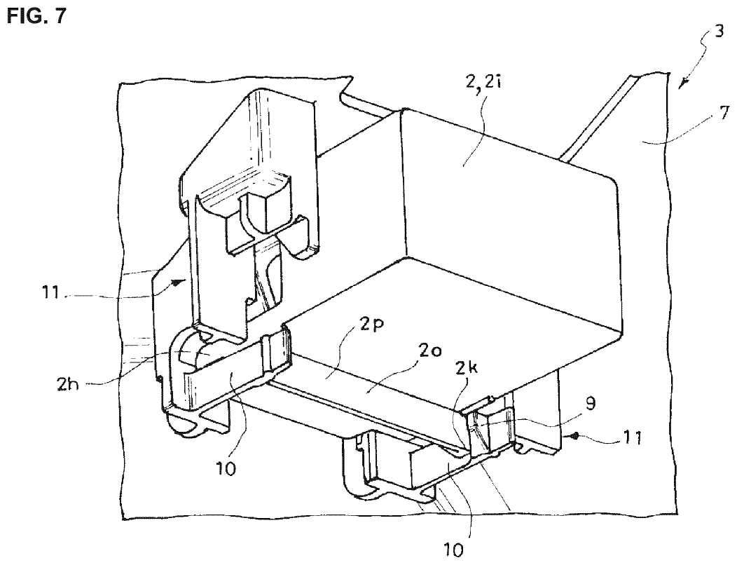

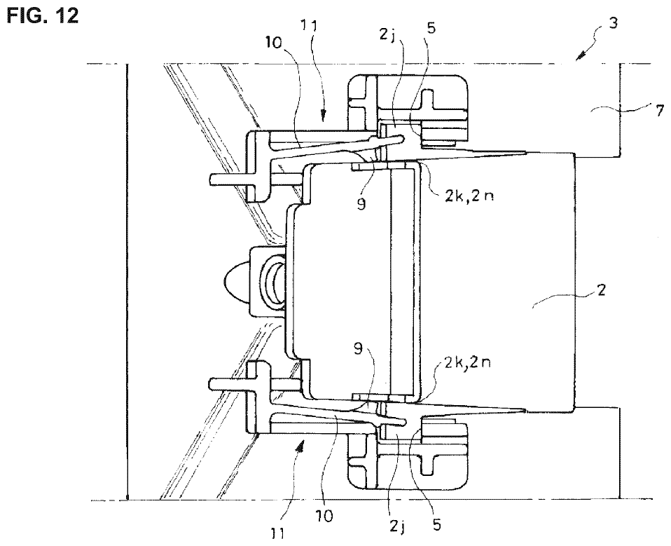

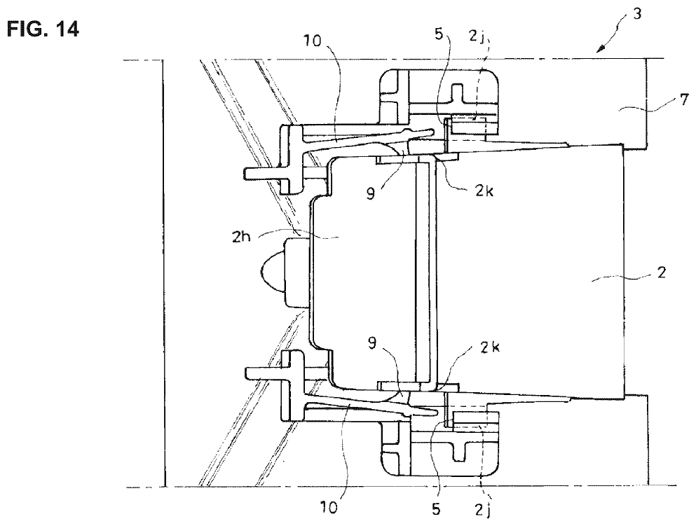

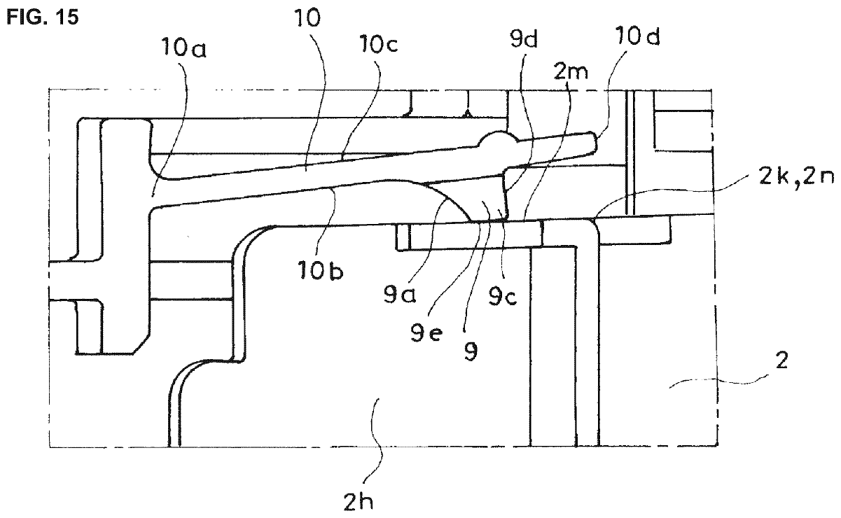

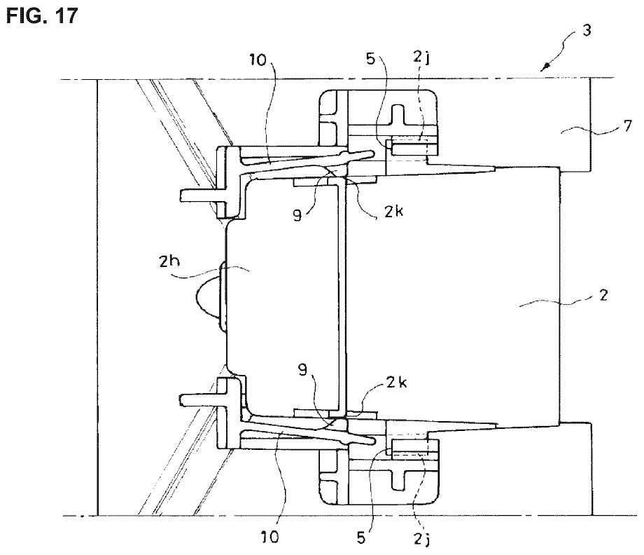

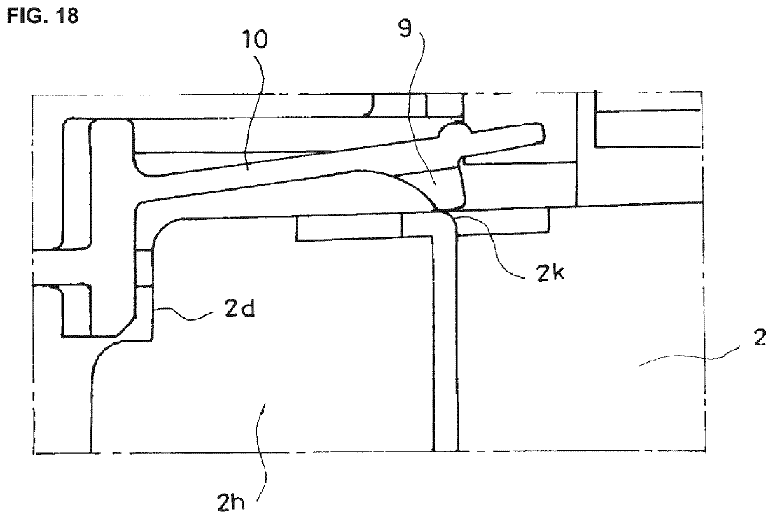

The following describes a typical embodiment of this invention on the basis of FIGS. 1 through 21. A bracket 3 according to the present embodiment is used to hold, on a body of a vehicle, a vehicle-mounted apparatus, such as a vehicle-mounted camera 2 that takes and senses an image outside the vehicle through a window glass of the vehicle. Typically, the bracket 3 described above is used to mount the vehicle-mounted camera 2, which takes an image outside the vehicle through the window glass of the vehicle, on the inside of a front window 1 or a rear window (not illustrated).

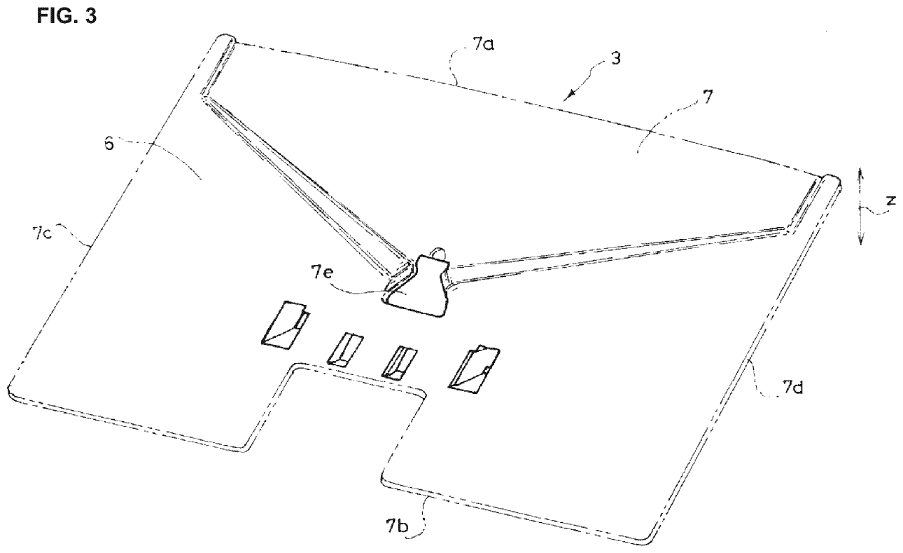

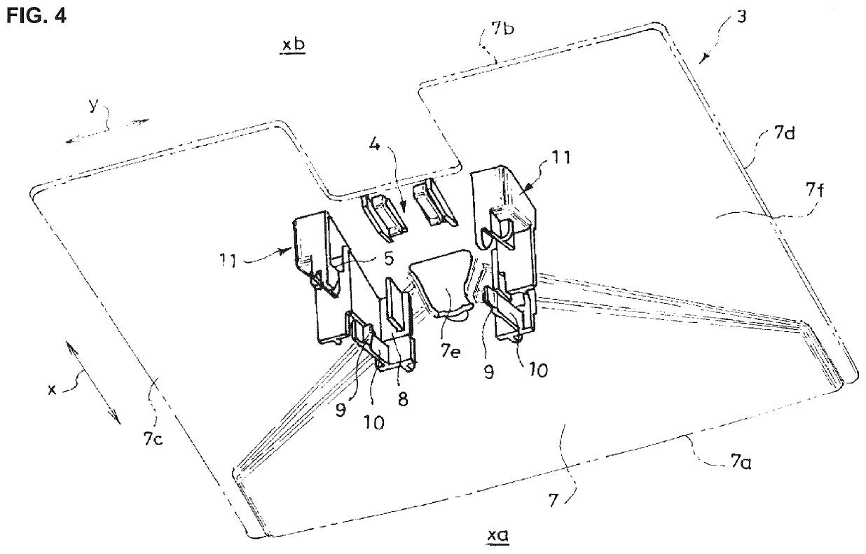

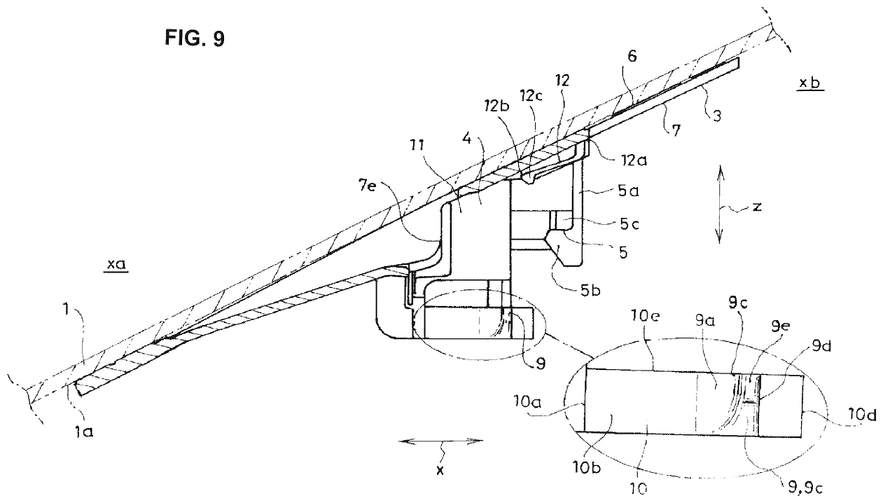

The illustration shows an example where the vehicle-mounted camera 2 is held via this bracket 3 on the inside of an upper portion of the front window 1. In the drawings, the front-rear direction of the vehicle is indicated by sign x in FIGS. 4 and 9, the front side of the vehicle by sign xa in FIGS. 4 and 9, and the rear side of the vehicle by sign xb in FIGS. 4 and 9. The left-right direction of the vehicle is indicated by sign y in FIG. 4, and the upper-lower direction is indicated by sign z in FIGS. 3 and 9.

As illustrated in FIG. 9, the front window 1 has a tilt with the front side xa of the vehicle to be the lower tilt. The bracket 3 is fixed to a face la of the front window 1 on the interior side.

In the present embodiment, the vehicle-mounted camera 2 is held in the bracket 3 by moving operation of the vehicle-mounted camera 2 toward a second position described below with respect to a receiving part 4 of the bracket 3 fixed to the face of the front window 1 on the interior side.

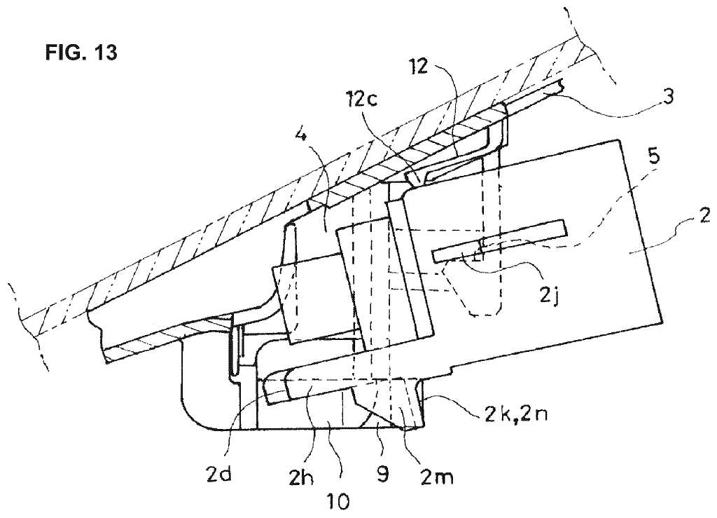

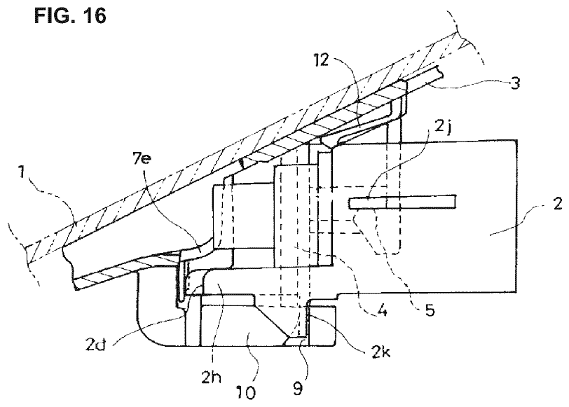

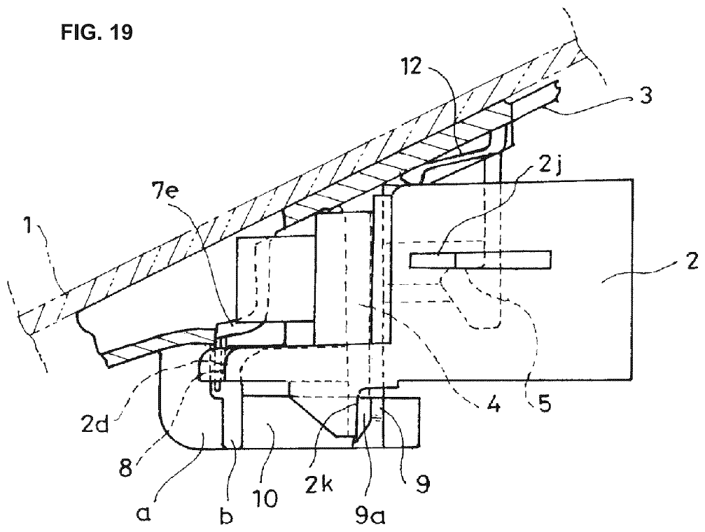

In the illustrated example, the vehicle-mounted camera 2 is held by the bracket 3 by moving operation of the vehicle-mounted camera 2 from the first position (FIG. 13) of the vehicle-mounted camera 2, where supported portions 2j described below of the vehicle-mounted camera 2 are supported by supporting portions 5 described below of the bracket 3 and the portion of the bracket 3 forming engaged portions 2k described below of the vehicle-mounted camera 2 is not fully contained in the receiving part 4, to the second position (FIG. 16, FIG. 19), where the portion of the bracket 3 forming the engaged portions 2k of the vehicle-mounted camera 2 is fully contained in the receiving part 4, with the supported portions 2j used as the fulcrum.

In the illustrated example, the vehicle-mounted camera 2 is in an oblique position with its front portion 2d down and rear portion 2e up, and the supported portion 2j is received from the front side into the supporting portions 5 of the bracket 3, and in this received state, the vehicle-mounted camera 2 in the oblique position is supported by the supporting portions 5. In the illustrated example, this oblique state is the first position described above.

In the illustrated example, the vehicle-mounted camera 2 is held in the bracket 3 by lifting the front portion 2d or its vicinity of the vehicle-mounted camera 2 from the first position using the supported portion 2j as a fulcrum, and performing moving operation of the vehicle-mounted camera 2 until it becomes substantially horizontal. In the illustrated example, this horizontal state is the second position.

In the second position, the vehicle-mounted camera 2 is held by the bracket 3 without rattling in the three directions of the front-rear direction x, the left-right direction y, and the upper-lower direction z with respect to the bracket 3.

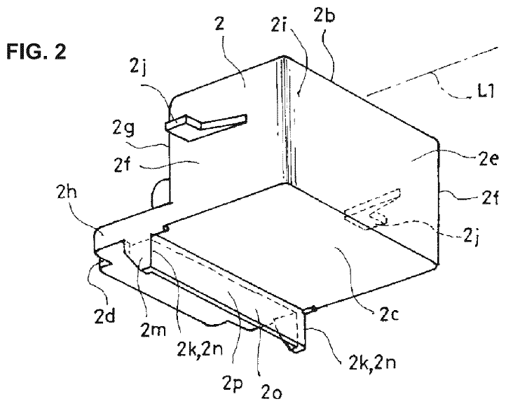

In the illustrated example, the vehicle-mounted camera 2 is mounted on the front window 1 via the bracket 3 with a light-entering part 2a for imaging to face the front side xa of the vehicle. In FIGS. 1 and 2, sign 2b indicates the upper portion of the vehicle-mounted camera 2, sign 2c indicates the bottom portion of the vehicle-mounted camera 2, sign 2d indicates the front portion of the vehicle-mounted camera 2, sign 2e indicates the rear portion of the vehicle-mounted camera 2, sign 2f indicates the side portions of the vehicle-mounted camera 2, sign 2h indicates the board-shaped portion of the vehicle-mounted camera 2, and sign 2i indicates the block-shaped portion of the vehicle-mounted camera 2.

In the illustrated example, the vehicle-mounted camera 2 has a step 2g between the front portion 2d and the rear portion 2e, on the face where the upper portion 2b is located, the step 2g facing the front side xa, and has the light-entering part 2a on this step 2g. The vehicle-mounted camera 2 has the board-shaped portion 2h with a smaller dimension in the upper-lower direction z between the front portion 2d and the step 2g. The vehicle-mounted camera 2 has the block-shaped portion 2i with a dimension larger than that of the board-shaped portion 2h in the upper-lower direction z between the step 2g and the rear portion 2e. That is, the upper face of the board-shaped portion 2h is lower than the upper face of the block-shaped portion 2i, but the bottom faces of both are flush.

In the block-shaped portion 2i, the left and right side portions 2f of the vehicle-mounted camera 2 are each provided with a supported portion 2j that is supported by the supporting portion 5 of the bracket 3. In the illustrated example, each supporting portion 5 protrudes from the side portion 2f of the vehicle-mounted camera 2 along the left-right direction y, and has a plate shape extending in the front-rear direction x and having a thickness in the upper-lower direction z. The left and right supported portions 2j have substantially the same dimensions and shape, and are formed symmetrically across a virtual center line L1 (refer to FIGS. 1 and 2) that bisects the vehicle-mounted camera 2 into left and right halves.

The board-shaped portion 2h is formed with the engaged portions 2k on its left and right sides, respectively. Thus, the vehicle-mounted camera 2 has the engaged portions 2k on its left and right side portions 2f, respectively.

The left and right engaged portions 2k each have a protrusion shape with an outer face 2m that is flush with the side face of the board-shaped portion 2h that forms part of the side portion 2f of the vehicle-mounted camera 2, and protrude downward from the board-shaped portion 2h.

The left and right engaged portions 2k have substantially the same dimensions and shape, and are formed symmetrically across the virtual center line L1 that bisects the vehicle-mounted camera 2 into left and right halves.

In the illustrated example, the bottom face of the board-shaped portion 2h has a rib 20 spanning between the left and right engaged portions 2k. A face 2p of this rib 20 facing the rear portion 2e of the vehicle-mounted camera 2 and the outer face 2m of the engaged portion 2k intersect at a right angle. A corner 2n where these two faces 2p and 2m intersect is in contact with a slope 9a of an engaging portion 9 described below when the vehicle-mounted apparatus is in the second position.

The bracket 3 has a fixing portion 6 to the body of the vehicle, and the portion opposite to the portion with the fixing portion 6 is the receiving part 4 for the vehicle-mounted camera 2.

In the illustrated example, the bracket 3 has a base plate portion 7 with substantially four sides: a front side 7a, a rear side 7b, a left side 7c, and a right side 7d. The bracket 3 is fixed to the face la of the front window 1 on the interior side by adhesion or other means on the upper face of the base plate portion 7. In other words, the upper face of this base plate portion 7 serves as the fixing portion 6. Since the front window 1 has a forward-descending slope, in the fixed state described above, the base plate portion 7 is also inclined to follow the slope, and the rear side 7b is positioned higher than the front side 7a. Indicated by sign 7e in FIG. 1 is an open portion formed in the base plate portion 7 corresponding to the light-entering part 2a of the vehicle-mounted camera 2.

The receiving part 4 of the bracket 3 has positioning wall portions 8 for the front portion 2d or rear portion 2e of the vehicle-mounted camera 2 as the vehicle-mounted apparatus, engaging portions 9 for the engaged portions 2k formed on the side portions 2f of the vehicle-mounted camera 2, and the supporting portions 5 that enable support of the supported portions 2j formed on the vehicle-mounted camera 2 at different positions from the engaging portions 9.

In addition, the engaging portions 9 are respectively formed in elastically deformable portions 10 that constitutes the receiving part 4.

In the present embodiment, the open portion 7e is formed in the center of the base plate portion 7.

On each of the left and right sides with the open portion 7e between them, the positioning wall portion 8 is formed on the front side, the supporting portion 5 is formed on the rear side, and the elastically deformable portion 10 is formed with the engaging portion 9 positioned in the middle between the positioning wall portion and the supporting portion.

The left side positioning wall portion 8, the supporting portion 5, and the elastically deformable portion 10 constitute a left side receiving part outline 11 protruding downward on a lower face 7f of the base plate portion 7, and the right side positioning wall portion 8, the supporting portion 5, and the elastically deformable portion 10 constitute a left side receiving part outline 11 protruding downward on a lower face 7f of the base plate portion 7, both receiving part outlines 11 form the receiving part 4 inside them.

The vehicle-mounted camera 2 is held by the bracket 3 in the space enclosed by these left and right receiving part outlines 11 and the base plate portion 7. Specifically, the vehicle-mounted camera 2 is held in the bracket 3 with its upper portion 2b touching the lower face 7f of the base plate portion 7, its left side portion 2f touching the left side receiving part outline 11, its right side portion 2f touching the right side receiving part outline 11, and its front portion 2d touching the left side receiving part outline 11 and the positioning wall portion 8 located on the front side of the right side receiving part outline 11 (refer to FIGS. 19 to 21).

In the illustrated example, the vehicle-mounted camera 2 is held in the bracket 3 with its rear portion 2e protruding from the receiving part 4. A decorative cover, not illustrated, may be removably attached below the bracket 3 that holds the vehicle-mounted camera 2 in this manner.

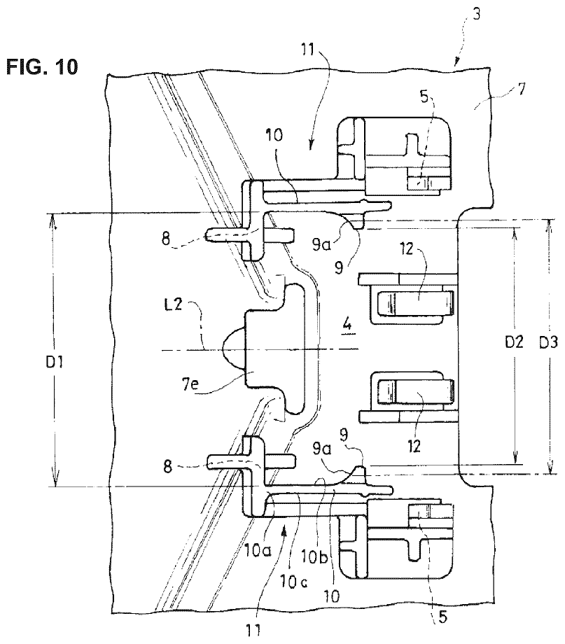

The elastically deformable portion 10 and the engaging portion 9 are provided on each side of the hypothetical center line L2 (refer to FIG. 10) along the front-rear direction x that bisects the receiving part 4 into left and right halves, with the engaging portion 9 protruding toward the center line L2.

Then, one of the left and right receiving part outlines 11 has a form that is lineally symmetrical to the other with respect to the center line L2.

In the illustrated example, the positioning wall portion 8 faces rearward and includes a plate body 8a protruding downward from the lower face 7f of the base plate portion 7. Between the positioning wall portion 8, which constitutes the left side receiving part outline 11, and the positioning wall portion 8, which constitutes the right side receiving part outline 11, the receiving part 4 is open to the front side.

In the illustrated example, the supporting portion 5 includes the upper portion of a claw 5b that protrudes forward from the tip of a leg 5a that protrudes downward from the lower face 7f of the base plate portion 7 (refer to FIG. 9). A space is formed between the supporting portion 5 and the lower face 7f of the base plate portion 7 to accommodate the portion between the supported portion 2j in the block-shaped portion 2i of the vehicle-mounted camera 2 and the upper portion 2b of the vehicle-mounted camera 2 without rattling.

In the illustrated example, the elastically deformable portion 10 is strip-shaped, extending along the front-rear direction x from a base 10a located near the positioning wall portion 8.

The elastically deformable portion 10 integrates the base 10a into the positioning wall portion 8 formed on the most front side xa of the receiving part outline 11, in front of the supporting portion 5, and is located below the supporting portion 5 as a whole. A space is formed between the elastically deformable portion 10 and the lower face 7f of the base plate portion 7, which is positioned directly above the elastically deformable portion 10, to accommodate the board-shaped portion 2h of the vehicle-mounted camera 2. In the second position, the light-entering part 2a of the vehicle-mounted camera 2 above the board-shaped portion 2h enters the open portion 7e.

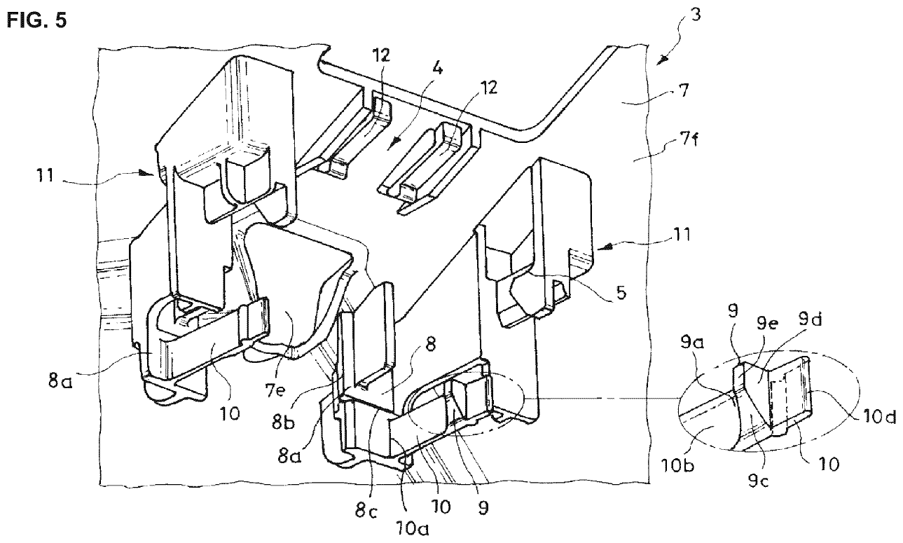

The elastically deformable portion 10 has a rectangular plate shape extending in the front-rear direction x in the lateral view. The elastically deformable portion 10 has an inner face 10b directed toward the center line L2 and an outer face 10c opposite to the inner face 10b, and has a thickness in the left-right direction y. The elastically deformable portion 10 is spaced in the left-right direction y from an edge 8b, facing the center line L2, of the plate body 8a constituting the positioning wall portion 8, the base 10a is integrated into this plate body 8a, and the positioning wall portion 8 is positioned closer to the center line L2 than the inner face 10b of the elastically deformable portion 10 is positioned (refer to FIG. 5).

The engaging portion 9 is provided in a protruding shape between a mid-position of the elastically deformable portion 10 in the front-rear direction and a free end 10d, that is, near the free end 10d. The engaging portion 9 protrudes from the inner face 10b of the elastically deformable portion 10 toward the center line L2.

The engaging portion 9 has the slope 9a facing the positioning wall portion 8, a support face 9b facing upward, and a guide face 9c below the support face 9b, the guide face 9c decreasing the amount of protrusion of the engaging portion 9 as it extends downward (refer to FIGS. 5 and 9).

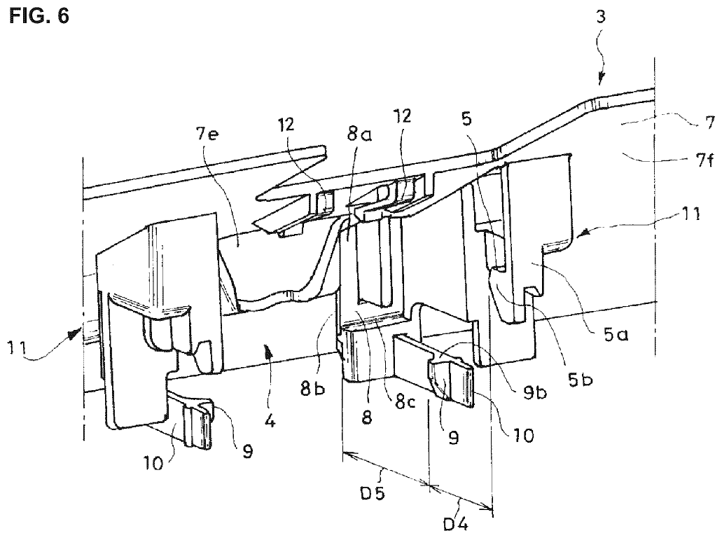

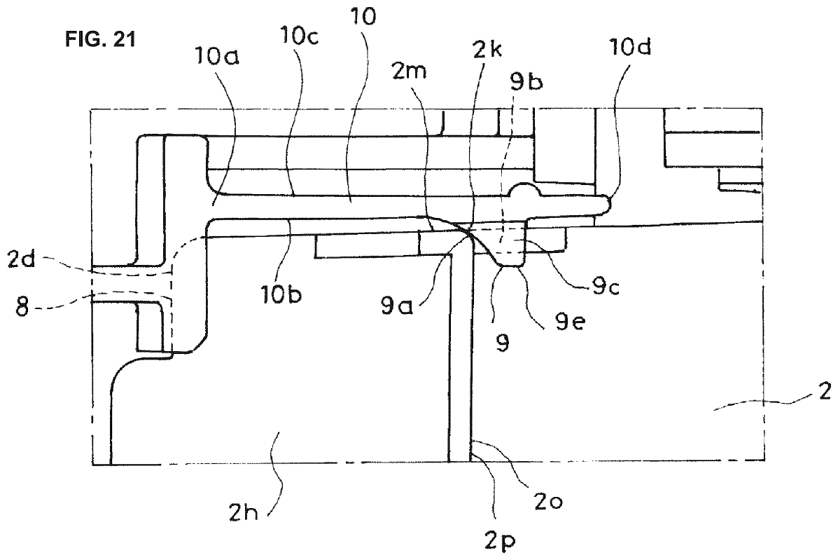

The slope 9a slopes closer to the center line L2 as it extends toward the rear side. A distance is provided between the engaging portion 9 and the free end 10d of the elastically deformable portion 10, and a back face 9d facing the free end 10d in the engaging portion 9 is a plane oriented orthogonally to the center line L2. Between the slope 9a and the back face 9d is formed a top face 9e of the engaging portion 9, which is substantially parallel to the center line L2. The top face 9e is the area bounded by the slope 9a, the back face 9d, the guide face 9c, and the support face 9b. The distance between the engaging portion 9 and the center line L2 is a minimum at the top face 9e, and the distance increases progressively toward the front side in the front-rear direction x and increases progressively downward in the upper-lower direction z. The support face 9b is flush with an upper face 10e in the thickness direction between the inner face 10b and outer face 10c of the elastically deformable portion 10 (refer to FIG. 6), and in the second position, a portion of the support face enters below the board-shaped portion 2h of the vehicle-mounted camera 2 by elastic return of the elastically deformable portion 10 as described below (refer to FIG. 21).

In the illustrated example, first, a distance D1 (FIG. 10) between the inner surface 10b of the portion where the engaging portion 9 is not formed in the elastically deformable portion 10 located on the left side across the center line L2 when viewed from below the bracket 3 and the inner face 10b of the portion where the engaging portion 9 is not formed in the elastically deformable portion 10 located on the right side across the center line L2 when viewed from below the bracket 3 is slightly larger than a dimension d1 (FIG. 1) of the board-shaped portion 2h of the vehicle-mounted camera 2 in the left-right direction y.

Second, a distance D2 (FIG. 10) between the top face 9e of the engaging portion 9 located on the left side across the center line L2 when viewed from below the bracket 3 and the top face 9e of the engaging portion 9 located on the right side across the center line L2 when viewed from below the bracket 3 is slightly smaller than the dimension d1 (FIG. 1) of the board-shaped portion 2h of the vehicle-mounted camera 2 in the left-right direction y.

Third, a distance D3 (FIG. 10) between the slope 9a of the engaging portion 9 located on the left side across the center line L2 as viewed from below the bracket 3 and the slope 9a of the engaging portion 9 located on the right side across the center line L2 as viewed from below the bracket 3 is slightly smaller than the dimension d1 (FIG. 1) of the board-shaped portion 2h of the vehicle-mounted camera 2 in the left-right direction y.

Fourth, a distance D4 (FIG. 6) in the front-rear direction x between the engaging portion 9 and the supporting portion 5 is substantially equal to a distance d2 (FIG. 1) in the front-rear direction x between the engaged portion 2k and the supported portion 2j.

Fifth, a distance D5 (FIG. 6) between the positioning wall portion 8 and the slope 9a of the engaging portion 9 is substantially equal to a distance d3 (FIG. 1) between the engaged portion 2k and the portion of the front portion 2d of the vehicle-mounted camera 2 corresponding to the positioning wall portion 8.

In this manner, the bracket 3 in the present embodiment first allows the moving operation of the vehicle-mounted camera 2 from the first position to the second position by deformation of the elastically deformable portion 10 due to the contact of the engaged portion 2k with the engaging portion 9.

In the illustrated example, first, in the bracket 3 fixed to the body of the vehicle (the front window 1 in the illustrated example), the supported portion 2j of the vehicle-mounted camera 2 is placed on the supporting portion 5 from the front side of the vehicle-mounted camera 2 from inside the cabin, and the vehicle-mounted camera 2 can be combined from below as an oblique posture with its front portion 2d down so that board-shaped portion 2h of the vehicle-mounted camera 2 does not enter on the elastically deformable portion 10 (FIG. 13/first position).

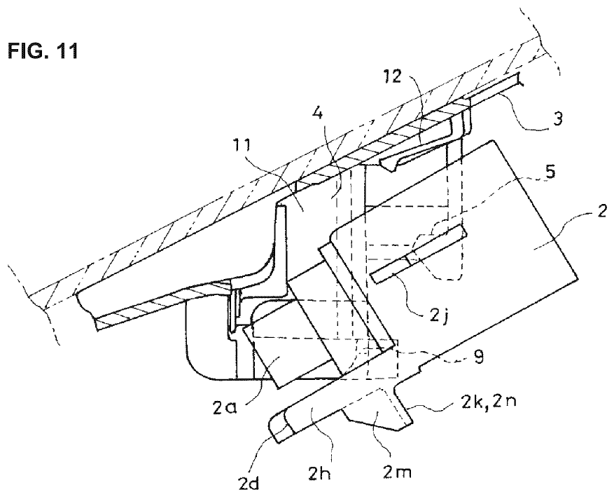

In the illustrated example, the vehicle-mounted camera 2 can first be inserted into the receiving part 4 in an oblique position with its front portion 2d down to a position where the respective supported portions 2j are positioned in front of the left and right supporting portions 5, while the left and right elastically deformable portions 10 of the bracket 3 are deformed together (FIG. 11).

Specifically, by bringing the engaging portion 9 into sliding contact with the side face of the board-shaped portion 2h that forms part of the side portion 2f of the vehicle-mounted camera 2 and the outer face 2m of the engaged portion 2k that is flush with the side face of the board-shaped portion 2h, the left and right elastically deformable portions 10 are elastically deformed toward away from the center line L2. This elastic deformation is smoothed by the guide faces 9c.

In other words, the left side engaged portion 2k of the vehicle-mounted camera 2 is in sliding contact with the engaging portion 9 of the left side receiving part outline 11, and the right side engaged portion 2k of the vehicle-mounted camera 2 is in sliding contact with the engaging portion 9 of the right side receiving part outline 11.

Then, by moving the vehicle-mounted camera 2 rearward from the state where the vehicle-mounted camera 2 is inserted into the receiving part 4 in this manner, the supported portions 2j are supported by the supporting portions 5, and the vehicle-mounted camera 2 is set in the first position (refer to FIGS. 11 to 13).

The distance between the left and right supporting portions 5 is slightly larger than the dimension of the block-shaped portion 2i of the vehicle-mounted camera 2 in the left-right direction y, but smaller than the distance between the left and right supported portions 2j. This allows the rear portion 2e and nearby portions of the vehicle-mounted camera 2 to be introduced from the front side between the left and right supporting portions 5, and in the first position, the supported portions 2j are supported by the supporting portions 5 by butting against the legs 5a.

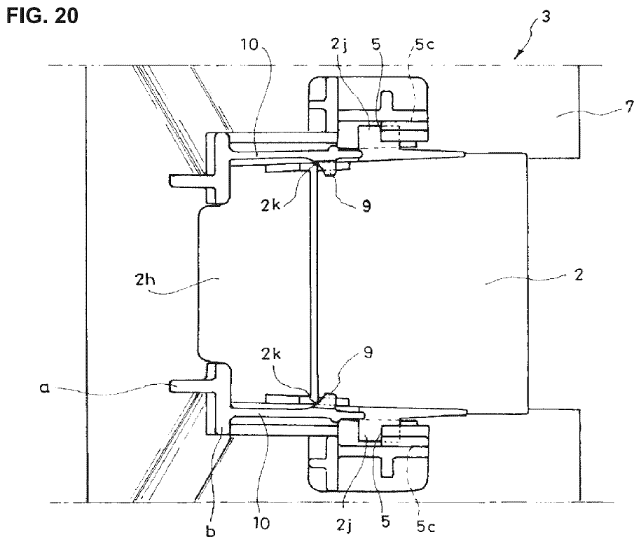

In the illustrated example, the outer sides of the left and right supporting portions 5 each have a contact 5c (refer to FIGS. 9 and 20) against the protruding end of the supported portion 2j.

In addition, the bracket 3 according to the present embodiment is designed to bring the vehicle-mounted camera 2 into contact with the positioning wall portions 8 in the second position and to prevent the vehicle-mounted camera 2 from returning to the first position by the elastic return of the elastically deformable portions 10.

In the illustrated example, in the process of moving operation of the vehicle-mounted camera 2 from the first position to the second position, each engaging portion 9 moves along the arc of a virtual circle centered on the supported portion 2j (refer to FIGS. 13 to 16).

When the vehicle-mounted camera 2 reaches the second position, the engaging portions 9 can enter under the board-shaped portion 2h of the vehicle-mounted camera 2, and the left and right elastically deformable portions 10 return elastically slightly toward the center line L2. In addition, the corner 2n of each engaged portion 2k is positioned behind the engaging portion 9 in the first position, but in the illustrated example, it is positioned in contact with the top face 9e of the engaging portion 9 immediately after reaching the second position (refer to FIGS. 16 to 18).

In the illustrated example, when the corner 2n of the engaged portion 2k is in contact with the top face 9e of the engaging portion 9 (refer to FIG. 16) and the vehicle-mounted camera 2 is pushed slightly further forward, the corner 2n of the engaged portion 2k moves forward of the top face 9e of the engaging portion 9 and contacts the slope 9a of the engaging portion 9 (refer to FIG. 19). In the second position, each supported portion 2j is oriented with its upper and lower faces substantially horizontally and its lower face is in contact with the supporting portion 5. Along with that, the supported portion 2j is set so that it cannot be dislodged from the supporting portion 5 by the push-in (refer to FIG. 19).

The slope 9a of the engaging portion 9 has a larger distance from the center line L2 than the top face 9e of the engaging portion 9 does, but a smaller distance from the center line L2 than the inner face 10b of the portion of the elastically deformable portion 10 where the engaging portion 9 is not formed. Therefore, in the second position, the elastically deformable portion 10 is elastically deformed even in the state illustrated in FIG. 19, where the corner 2n of the engaged portion 2k is in contact with the slope 9a of the engaging portion 9, as described above. However, the amount of elastic deformation is somewhat smaller than that in the state illustrated in FIG. 16.

In the second position, the upward-facing support face 9b constituting the engaging portion 9 can enter below the board-shaped portion 2h of the vehicle-mounted camera 2 due to the elastic return of the elastically deformable portion 10 (refer to FIG. 21). This prevents the vehicle-mounted camera 2 from returning to the first position. In the second position, the engaged portion 2k formed on the side portion 2f of the vehicle-mounted camera 2 contacts the slope 9a formed to face the positioning wall portion 8, which constitutes the engaging portion 9, between the positioning wall portion 8 and the engaging portion 9. The front portion 2d of the vehicle-mounted camera 2 is then brought into contact with the positioning wall portion 8 by the elastic force of the elastically deformable portion 10. This completes the holding of the vehicle-mounted camera 2 by the bracket 3 (FIG. 19/holding completion position).

In the illustrated example, the front portion 2d of the vehicle-mounted camera 2, which is composed of the board-shaped portion 2h, is brought into contact with the positioning wall portions 8 by the pushing from the state illustrated in FIG. 16, and support faces 8c are formed below the respective contact points, which enter below the board-shaped portion 2h by the pushing. These support faces 8c also prevent the vehicle-mounted camera 2 from returning to the first position (refer to FIG. 6).

The bracket 3 according to the present embodiment allows the moving operation to hold the vehicle-mounted camera 2 in the receiving part 4 by the deformation of the elastically deformable portion 10 due to the contact of the engaged portions 2k with the engaging portions 9, and the elastic return of the elastically deformable portions 10 brings the vehicle-mounted camera 2 into contact with the positioning wall portions 8 and prevents the vehicle-mounted camera 2 from slipping out of the receiving part 4. Therefore, the vehicle-mounted camera 2 can be held without requiring a separate structure, which forces the vehicle-mounted camera 2 against the positioning wall portions 8, in front or behind the vehicle-mounted camera 2. In addition, the bracket 3 can be made as simple and compact as possible because it does not require a separate structure on the left or right side of the vehicle-mounted camera 2 other than the elastically deformable portions 10 and the engaging portions 9, nor does it require a separate structure that protrudes below the vehicle-mounted camera 2.

The state in which the bracket 3 holds the vehicle-mounted camera 2 can be easily released by using the free ends 10d of the elastically deformable portions 10, which are positioned behind the respective engaging portions 9, to deform the elastically deformable portions 10 in the directions that disengage the engaged portions 2k and the engaging portions 9, in the illustrated example, away from the center line L2, which also allows easy disengagement of the vehicle-mounted camera 2 from the bracket 3. Specifically, after tilting the vehicle-mounted camera 2 to the first position by the release, the vehicle-mounted camera 2 can slide forward in the illustrated example, allowing the supported portions 2j to slip out forward from above the supporting portions 5, thereby removing the vehicle-mounted camera 2 from the receiving part 4.

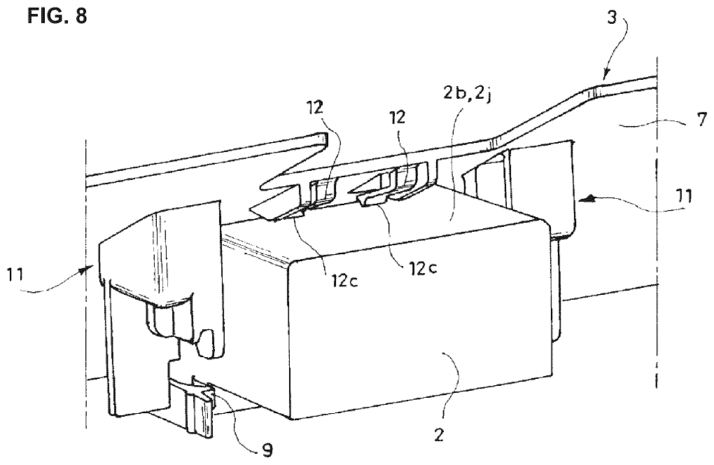

In the present embodiment, additional elastically deformable portions 12 are provided at the portion where it is pressed against the upper portion 2b of the vehicle-mounted camera 2 in the second position on the base plate portion 7 in the receiving part 4 (refer to FIGS. 8 and 19). The elastically deformable portions 10 are provided between the left and right receiving part outlines 11, on the respective sides of the center line L2 (refer to FIG. 10).

In the illustrated example, such additional elastically deformable portions 12 each include an elastic piece with a base 12a on the rear side xb, a free end 12b on the front side xa, and a convex portion 12c protruding downward near the free end 12b (refer to FIG. 9). When the vehicle-mounted camera 2 in the first position is moved to the second position, the upper face of the block-shaped portion 2i of the vehicle-mounted camera 2 hits the convex portions 12c, causing the additional elastically deformable portions 12 to flex upward, and the force generated by this presses the supported portions 2j against the supporting portions 5. The lower face of the board-shaped portion 2h, which forms part of the bottom portion 2c of the vehicle-mounted camera 2, is pressed against the engaging portions 9 and the support faces 8c to deter rattling of the vehicle-mounted camera 2 in the upper-lower direction z.

Although not illustrated in the drawings, the structure of the receiving part 4 of the bracket 3 described above is also valid in the reversed front-to-rear orientation. In other words, the bracket 3 according to the present invention can be configured such that the positioning wall portions 8 are respectively formed on the rear side xb of the left side receiving part outline 11 and the right side receiving part outline 11, which constitute the receiving part 4, and each elastically deformable portion 10 is formed with the base 10a on the rear side xb and the free end 10d on the front side xa, and the supporting portions 5 are formed on the front side xa of the receiving part outlines 11, respectively.

The imparting of elastic deformation characteristics to the portions and parts to be provided with elastic deformation characteristics in the above described embodiment can be easily ensured by making such portions, the whole including such portions, and such parts into plastic molded products.

Naturally, the present invention is not limited to the embodiments described above, but includes all embodiments that can achieve the purpose of the present invention.

### REFERENCE SIGNS LIST

2k Engaged portion
4 Receiving part
8 Positioning wall portion
9 Engaging portion
10 Elastically deformable portion
10a Base

The entire content of the specification, claims, drawings, and abstract of Japanese Patent Application No. 2022-122565, filed on Aug. 1, 2022, are hereby cited and incorporated as the disclosure of the specification of the present invention.

1. A bracket for a vehicle-mounted apparatus, the bracket being configured to hold, on a body of a vehicle, a vehicle-mounted apparatus for taking a picture or sensing outside of the vehicle through a window glass, the bracket comprising:
a fixing portion to the body of the vehicle, and a portion opposite to the fixing portion as a receiving part for at least a part of the vehicle-mounted apparatus, wherein
the receiving part includes
a positioning wall portion for a front portion or a rear portion of the vehicle-mounted apparatus, and
an elastically deformable portion having a strip shape extending along a front-rear direction from a base located to face the positioning wall portion,
the elastically deformable portion is provided with an engaging portion in a protruding shape for an engaged portion formed on a side portion of the vehicle-mounted apparatus, and
the bracket allows a moving operation of the vehicle-mounted apparatus to a holding completion position in the receiving part by deformation of the elastically deformable portion due to contact of the engaged portion with the engaging portion, and an elastic return of the elastically deformable portion brings the vehicle-mounted apparatus in the holding completion position into contact with the positioning wall portion and prevents the vehicle-mounted apparatus from slipping out of the receiving part.

2. A bracket for a vehicle-mounted apparatus, the bracket being configured to hold, on a body of a vehicle, a vehicle-mounted apparatus for taking a picture or sensing outside of the vehicle through a window glass, the bracket comprising:
a fixing portion to the body of the vehicle, and a portion opposite to the fixing portion as a receiving part for at least a part of the vehicle-mounted apparatus, wherein
the receiving part includes
a positioning wall portion for a front portion or a rear portion of the vehicle-mounted apparatus,
an engaging portion for an engaged portion formed on a side portion of the vehicle-mounted apparatus, and
a supporting portion that enables support of a supported portion formed on the vehicle-mounted apparatus at a different position from the engaging portion,
the engaging portion is formed in an elastically deformable portion in the receiving part, and
the bracket allows a moving operation of the vehicle-mounted apparatus from a first position of the vehicle-mounted apparatus, where the supported portion is supported by the supporting portion and a portion of the bracket forming the engaged portion of the vehicle-mounted apparatus is not fully contained in the receiving part, to a second position, where the portion of the bracket forming the engaged portion of the vehicle-mounted apparatus is fully contained in the receiving part, with the supported portion used as a fulcrum, by deformation of the elastically deformable portion due to contact of the engaged portion with the engaging portion, and elastic return of the elastically deformable portion brings the vehicle-mounted apparatus in the second position into contact with the positioning wall portion and prevents the vehicle-mounted apparatus from returning to the first position.

3. The bracket for a vehicle-mounted apparatus according to claim 2, wherein
the elastically deformable portion has a strip shape extending along a front-rear direction from a base located near the positioning wall portion,
the engaging portion is provided in a protruding shape at the elastically deformable portion, and
a slope formed to face the positioning wall portion and forming the engaging portion contacts the engaged portion in the second position.

4. The bracket for a vehicle-mounted apparatus according to claim 3, wherein a support face facing upward and forming the engaging portion enters below the vehicle-mounted apparatus in the second position.

5. The bracket for a vehicle-mounted apparatus according to claim 4, wherein a guide face is formed below the support face in the engaging portion, the guide face decreasing an amount of protrusion of the engaging portion as the guide face extends downward.

6. The bracket for a vehicle-mounted apparatus according to claim 2, comprising an additional elastically deformable portion that is pressed against an upper portion of the vehicle-mounted apparatus in the second position.

7. The bracket for a vehicle-mounted apparatus according to claim 1, wherein the elastically deformable portion is provided on each side of a hypothetical center line along a front-rear direction that bisects the receiving part into left and right halves, the elastically deformable portion being provided with the engaging portion protruding toward the center line, the engaging portion corresponding to the engaged portion formed on each of left and right side portions of the vehicle-mounted apparatus.
